(19) United States
(12) Patent Application Publication
(10) Pub. No.: US 2017/0309205 A1
(43) Pub. Date: Oct. 26, 2017

(54) LED MODULE AND SIGN BOX

(71) Applicant: GE Lighting Solutions, LLC, East Cleveland, OH (US)

(72) Inventors: Suping WANG, ShangHai (CN); Yongli FENG, Xian (CN); Yan NI, ShangHai (CN); Brian Morgan SPAHNIE, East Cleveland, OH (US)

(21) Appl. No.: 15/486,840

(22) Filed: Apr. 13, 2017

(30) Foreign Application Priority Data
Apr. 21, 2016 (CN) 201610254776.5

(51) Int. Cl. G09F 13/18; F21K 9/69; F21V 5/00; F21V 5/04; G09F 13/22; F21V 7/00; F21K 9/68; F21V 5/08; F21V 13/04; F21Y 2115/10; F21Y 2103/20

(52) U.S. Cl. CPC G09F 13/18; F21V 5/08; F21K 9/69; F21V 5/002; F21V 5/04; G09F 13/22; F21V 13/04; F21V 7/0091; F21K 9/68; F21Y 2115/10; F21Y 2103/20; G09F 2013/1881; G09F 2013/222

(57) ABSTRACT

An LED module is disclosed, which includes one or more LED light sources and one or more lenses. Each lens includes a lens body. The lens body includes an inner cavity having an incident surface, an emergent surface, and a reflective surface extending between the incident surface and the emergent surface for providing total internal reflection. One LED light source is situated in the inner cavity. Light emitted from the LED light source is transmitted by the incident surface. At least portion of transmitted light by the incident surface is reflected by the reflective surface to the emergent surface so as to provide a narrow light beam angle perpendicular to a length direction of the LED module. The emergent surface has a plurality of micro structures for enlarging a light viewing angle in the length direction. A sign box using one or more LED modules is also disclosed.

### BACKGROUND

This disclosure relates generally to LED lighting, and more particularly to a LED module and a sign box having the LED module.

Light emitting diodes (LEDs) have advantages over traditional lighting solutions such as incandescent and fluorescent lighting because they use less energy, are more durable, operate longer, can be combined in red-blue-green arrays that can be controlled to deliver virtually any color light, and contain no lead or mercury. Therefore, LED lighting systems are becoming more prevalent as replacements for existing lighting systems.

In many applications, one or more LEDs are mounted on an LED module, which may make up part of a lighting fixture such as illuminated signage, flat or shallow panel illumination fixtures, decorative lighting applications, and the like. For the shallow depth signage, its depth or space limitations may limit size of the LED module mounted thereon. However, conventional LED modules usually have larger size, so it is difficult for such larger LED modules to be used in very shallow depth signage.

As a result, improvements are desired for the LED module in the shallow depth illumination applications.

### BRIEF DESCRIPTION

In one embodiment, the present disclosure provides an LED module. The LED module comprises one or more LED light sources, and one or more lenses for covering the one or more LED light sources. Each lens comprises a lens body. The lens body comprises an inner cavity having an incident surface, an emergent surface, and a reflective surface extending between the incident surface and the emergent surface for providing total internal reflection. One LED light source is situated in the inner cavity. Light emitted from the LED light source is transmitted by the incident surface. At least portion of transmitted light by the incident surface is reflected by the reflective surface to the emergent surface so as to provide a narrow light beam angle perpendicular to a length direction of the LED module. The emergent surface has a plurality of micro structures for enlarging a light viewing angle in the length direction of the LED module.

In another embodiment, the present disclosure provides a sign box. The sign box comprises a box body having four side edges, and one or more LED modules above-mentioned. The one or more LED modules are mounted on at least one side edge of the box body along the length direction of the LED module.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective diagram of an exemplary LED module in accordance with an embodiment of the present disclosure;

FIG. 2 is a top view of the LED module of FIG. 1;

FIG. 3 is a perspective diagram of the LED module similar to FIG. 1, but a half of the LED module is cut so as to show an internal construction of the LED module;

FIG. 4 is a perspective diagram of a lens of the LED module in FIG. 3, wherein a half of the lens is cut so as to show an internal construction of the lens;

FIG. 5 is a schematic diagram of light redirected by the lens of FIG. 4; and

FIG. 6 is a perspective diagram of an exemplary sign box in accordance with an embodiment of the present disclosure.

### DETAILED DESCRIPTION

Embodiments of the present disclosure will be described herein below with reference to the accompanying drawings. In the following description, well-known functions or constructions are not described in detail to avoid obscuring the disclosure in unnecessary detail.

Unless defined otherwise, technical and scientific terms used herein have the same meaning as is commonly understood by one of ordinary skill in the art to which this disclosure belongs. The terms “first”, “second”, “third” and the like, as used herein do not denote any order, quantity, or importance, but rather are used to distinguish one element from another. Also, the terms “a” and “an” do not denote a limitation of quantity, but rather denote the presence of at least one of the referenced items. The term “or” is meant to be inclusive and mean either or all of the listed items. The use of “including,” “comprising” or “having” and variations thereof herein are meant to encompass the items listed thereafter and equivalents thereof as well as additional items. The terms “connected” and “coupled” are not restricted to physical or mechanical connections or couplings, and can include electrical connections or couplings, whether direct or indirect. In addition, Terms indicating specific locations, such as “top”, “bottom”, “front”, and “rear”, are descriptions with reference to specific accompanying drawings. Embodiments disclosed in the present disclosure may be placed in a manner different from that shown in the figures. Therefore, the location terms used herein should not be limited to locations described in specific embodiments.

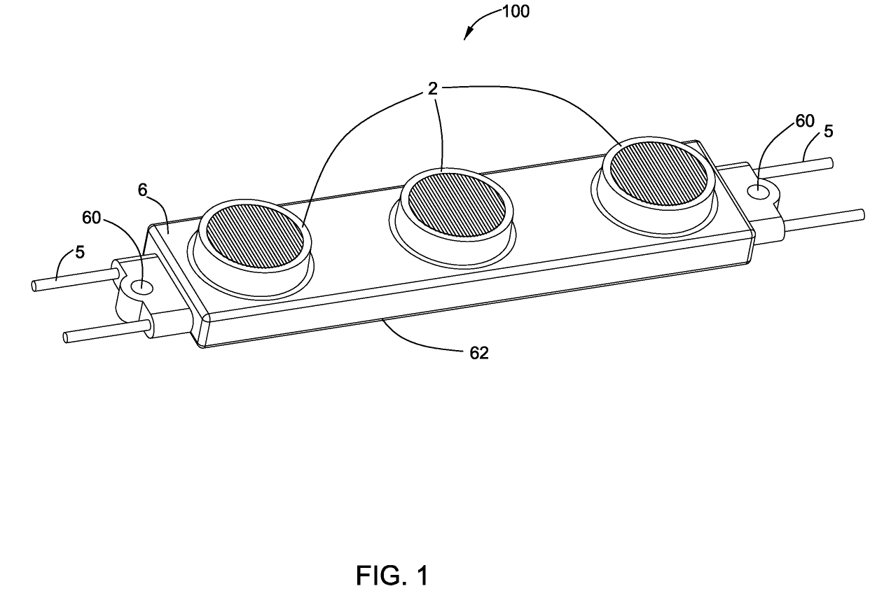

FIGS. 1-3 illustrate a perspective diagram of an exemplary LED module 100 in accordance with an embodiment of the present disclosure. As shown in FIGS. 1-3, the exemplary LED module 100 may include one or more LED light sources 1, and one or more lenses 2 for covering the one or more LED light sources 1. The lenses 2 have the number corresponding to that of the LED light sources 1. One lens 2 may cover one LED light source 1. As an example, in the figures of the present disclosure, the LED module 100 is illustrated to include three LED light sources 1 that are spaced apart from each other, and correspondingly include three lenses 2. However, the number of the LED light sources 1 and the lenses 2 included in the LED module 100 should not be limited hereinto. The lens 2 may be a transparent material. For example, the lens 2 may be constructed of acrylic or polycarbonate material.

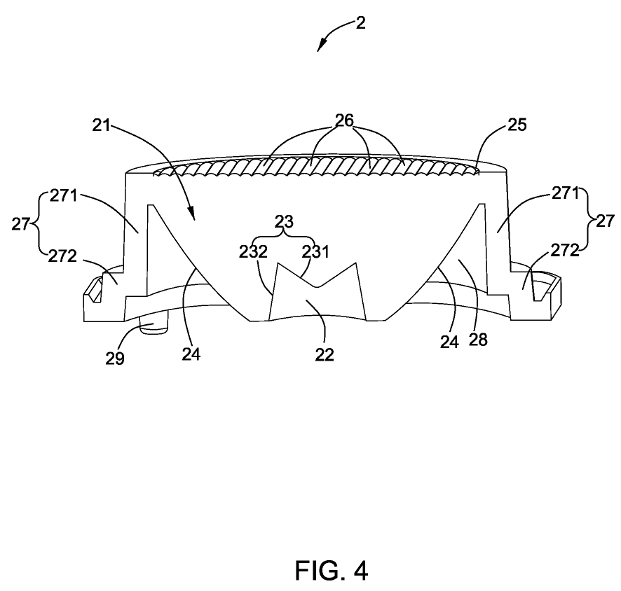

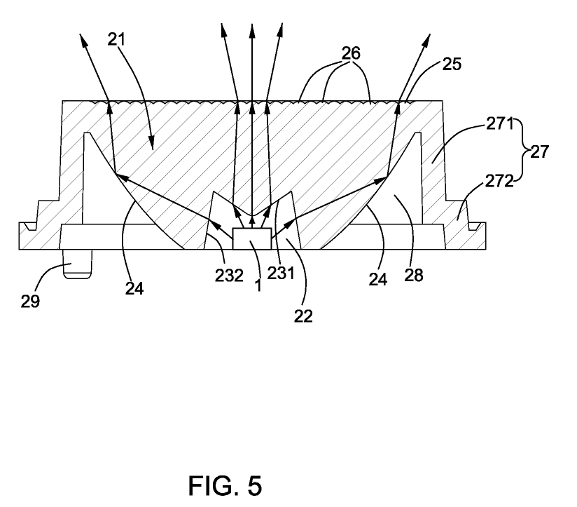

With reference to FIGS. 4-5, each lens 2 includes a lens body 21. In this embodiment, the lens body 21 may be generally bowl-shaped. The lens body 21 includes an inner cavity 22 at the bottom thereof. One LED light source 1 may be situated in the inner cavity 22 of the lens body 21. The inner cavity 22 of the lens body 21 has an incident surface 23, and the lens body 21 further has an emergent surface 25, and a reflective surface 24. The emergent surface 25 is at the top of the lens body 21. The reflective surface 24 may extend between the incident surface 23 and the emergent surface 25, and the reflective surface 24 may provide total internal reflection (TIR).

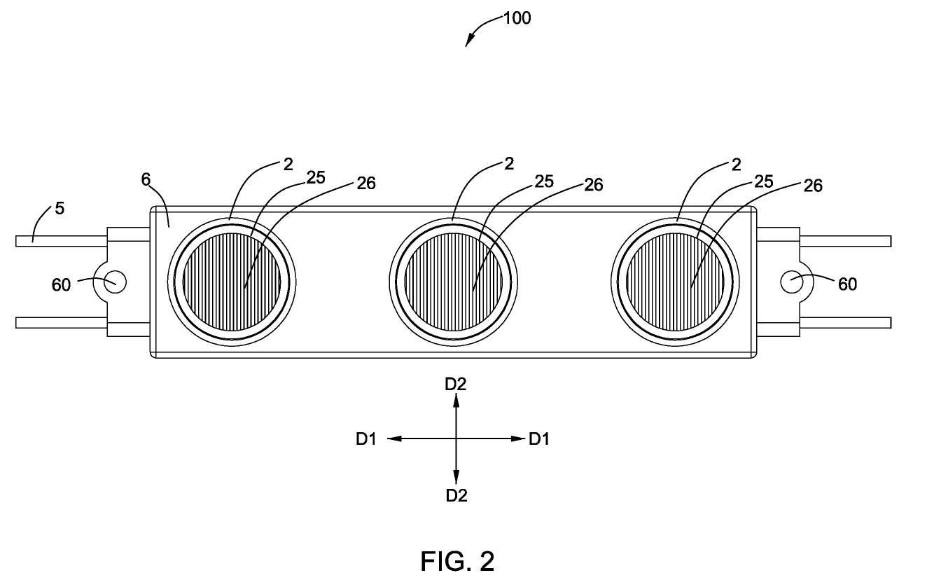

As shown in FIG. 5, light emitted from the LED light source 1 may be transmitted by the incident surface 23 of the lens body 21. At least portion of transmitted light by the incident surface 23 may be reflected by the reflective surface 24 to the emergent surface 25 so as to provide a narrow light beam angle perpendicular to a length direction (as shown in arrow D1-D1 of FIG. 2) of the LED module 100. The narrow light beam angle perpendicular to the length direction D1-D1 may be less than 25 degrees. In one embodiment, the narrow light beam angle may be for example about 15 degrees.

With reference to FIGS. 4 and 5, the incident surface 23 of the lens body 21 may have a first incident surface 231 and a second incident surface 232. The light transmitted by the first incident surface 231 may be incident on the emergent surface 25, and the light transmitted by the second incident surface 232 may be incident on the reflective surface 24 and may be reflected by the reflective surface 24 to the emergent surface 25. The first incident surface 231 is recessed toward the LED light source 1. In one embodiment, the first incident surface 231 may have a cone shape. In another embodiment, the first incident surface 231 may have a spherical cap shape.

As shown in FIGS. 2-5, the emergent surface 25 of the lens body 21 may have a plurality of micro structures 26. The plurality of micro structures 26 may enlarge a light viewing angle in the length direction D1-D1 of the LED module 100. The plurality of micro structures 26 may be integrally injection-molded with the lens 2. The plurality of micro structures 26 may be a plurality of micro protrusions from the lens body 21. In order to protect the plurality of micro structures 26, the tops of the plurality of micro structures 26 may be not beyond a top surface of the lens 2. For example, as shown in FIGS. 4 and 5, the peripheral area of the top surface of the lens 2 is slightly higher than the tops of the plurality of micro structures 26.

In one embodiment, the plurality of micro structures 26 may include a plurality of micro strip structures 26 (i.e. a plurality of micro strip-shaped protrusions). However, the plurality of micro structures 26 should be not limited hereinto. Any features, which have smaller size and may realize the function of enlarging the light viewing angle in the length direction D1-D1 of the LED module 100 should be covered in the protective scope of the micro structures 26 of the present disclosure. After the light passes through the emergent surface 25 with the plurality of micro strip structures 26, the light viewing angle in the length direction D1-D1 of the LED module 100 may be increased greatly. The light viewing angle in the length direction D1-D1 may be larger than 30 degrees.

With continued reference to FIG. 2, the plurality of micro strip structures 26 may be arranged along a direction (i.e. direction D1-D1) in parallel to the length direction D1-D1, and each micro strip structure 26 extends along a direction (i.e. direction D2-D2) perpendicular to the length direction D1-D1. In one embodiment, the micro strip structure 26 on the emergent surface 25 may have an arc cross section. As an example, the micro strip structure 26 having the arc cross section may have a height of about 0.1-0.12 mm in a direction vertical to the emergent surface 25 and have a width of about 0.5-0.6 mm in the direction D1-D1. In another embodiment, the micro strip structure 26 may also have a triangle cross section. Certainly, the micro strip structure 26 may also have a cross section of other shape. The plurality of micro strip structures 26 may be uniformly distributed on the emergent surface 25.

The lens body 21 may have a rotationally symmetrical shape except for the plurality of micro structures 26. After the light passes through the lens 2, asymmetric light distribution may be obtained due to the plurality of micro structures 26. By adopting the lens 2 with asymmetric light distribution, the LED module 100 of the present disclosure may get small size and good uniformity. The LED module 100 of the present disclosure may be a small and slim LED module and thus may be well applied to the shallow depth illumination applications.

Furthermore, when such the LED module 100 is used in an illumination fixture, the longer throw light may be obtained in the illumination fixture with the fewer LED modules 100. Thus, the number of LED module 100 used in the illumination fixture may be saved and product cost may be reduced.

In an optional embodiment, the lens 2 may further include a mounting portion 27 surrounding the lens body 21. In this embodiment, the mounting portion 27 may be generally cylindrical. An outer cavity 28 may be formed between the mounting portion 27 and the lens body 21. The mounting portion 27 may include an outer circumference wall 271 extending from the emergent surface 25 and a mounting foot 272 located at a free end of the outer circumference wall 271. The outer circumference wall 271 may have the effect of sealing and waterproof. The mounting foot 272 may facilitate mounting and fixing of the lens 2 in the subsequent over-molding process.

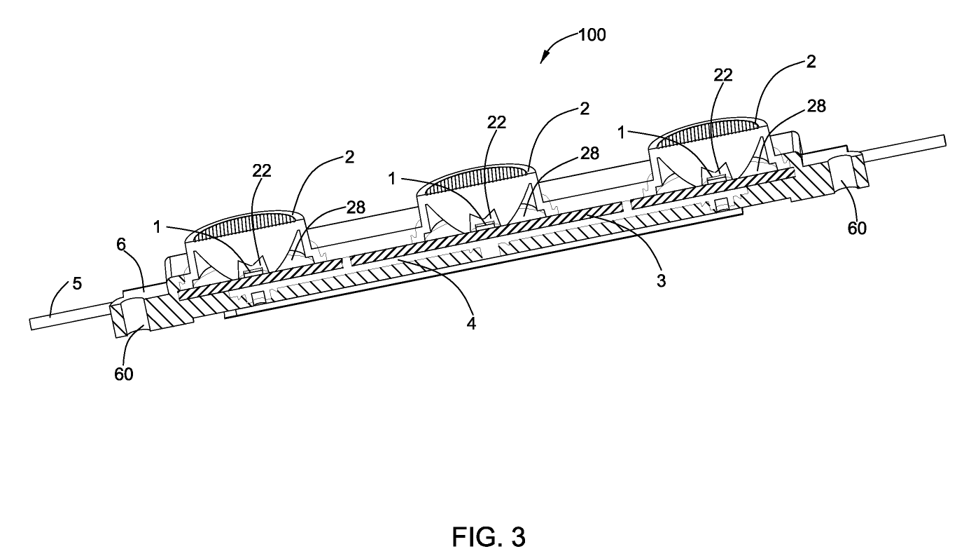

Returning to FIG. 3, the LED module 100 may include a printed circuit board assembly (PCBA) 3, electrical leads 5 and an over-molded plastic body 6. The three LED light sources 1 may be spacedly mounted on the printed circuit board assembly 3. Each lens 2 may further have a positioning post 29. By the positioning post 29 of the lens 2, the lens 2 may be positioned onto the printed circuit board assembly 3. The electrical leads 5 may be connected to the printed circuit board assembly 3. The over-molded plastic body 6 may seal the three LED light sources 1, the three lenses 2 and the printed circuit board assembly 3 together. As an example, the over-molded plastic body 6 may be a thermoplastic material. The electrical leads 5 may extend from the printed circuit board assembly 3 at the interior of the LED module 100 to the exterior of the LED module 100 after the over-molding process. The over-molded plastic body 6 of the LED module 100 may have a pair of mounting holes 60. By the pair of mounting holes 60 and a pair of fasteners (not shown), the LED module 100 may be mounted onto an illumination fixture.

In order to prevent deformation of the printed circuit board assembly 3 in the over-molding process, the LED module 100 may further include a gasket 4 which is located under the printed circuit board assembly 3, and may support the printed circuit board assembly 3.

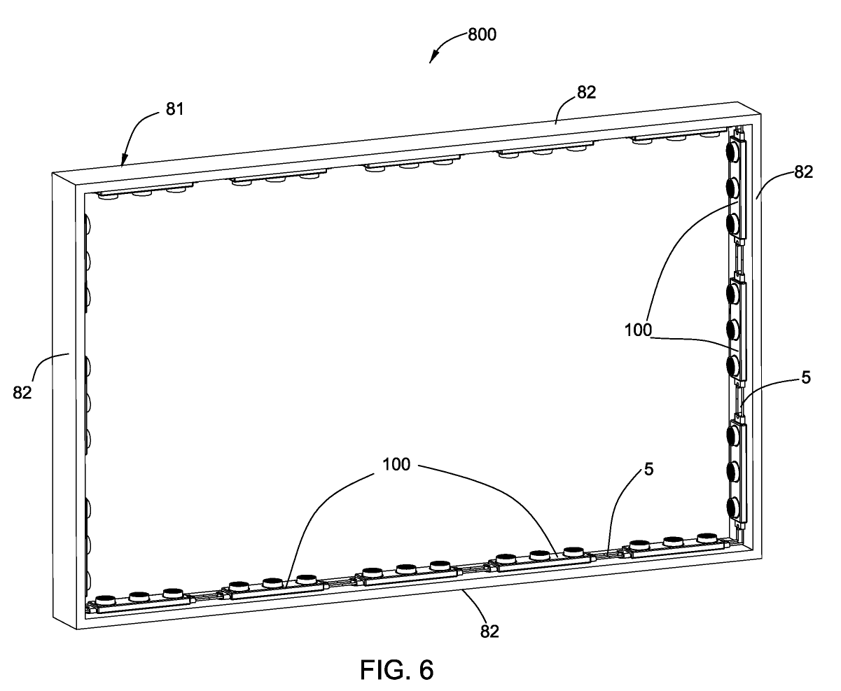

The present disclosure may further provide a sign box 800. FIG. 6 illustrates a perspective diagram of an exemplary sign box 800 in accordance with an embodiment of the present disclosure. As shown in FIG. 6, the exemplary sign box 800 may include a box body 81, and one or more LED modules 100. In one embodiment, the sign box 800 may be a side emitting sign box 800. The side emitting sign box 800 may have only about 3 inches depth.

The box body 81 may for example have four side edges 82. The one or more LED modules 100 may be mounted on at least one side edge 82 of the box body 81 along the length direction D1-D1 of the LED module 100. As an example, the more LED modules 100 may be mounted on the four side edges 82 of the box body 81. The more LED modules 100 may be interconnected with each other by individual electrical leads 5.

When the LED module 100 is assembled onto the side edge 82 of the box body 81, a rear surface 62 (as shown in FIG. 1) of the LED module 100 may be first pasted onto the side edge 82 of the box body 81 by an adhesive, and the LED module 100 may be then secured onto the side edge 82 of the box body 81 by the pair of fasteners respectively passing through the pair of mounting holes 60 in the LED module 100.

The sign box 800 adopting such the LED module 100 of the present disclosure may have a shallow depth and small size.

Moreover, In comparison to using conventional LED modules, the sign box 800 adopting such the LED module 100 of the present disclosure may use fewer LED modules 100 to satisfy desired lighting distribution, and may thus reduce product cost greatly.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the following claims.

What is claimed is:

1. An LED module comprising:
one or more LED light sources; and
one or more lenses for covering the one or more LED light sources, each lens comprising a lens body and the lens body comprising an inner cavity having an incident surface, an emergent surface, and a reflective surface extending between the incident surface and the emergent surface for providing total internal reflection,
wherein one LED light source is situated in the inner cavity, light emitted from the LED light source is transmitted by the incident surface, at least portion of transmitted light by the incident surface is reflected by the reflective surface to the emergent surface so as to provide a narrow light beam angle perpendicular to a length direction of the LED module, and
wherein the emergent surface has a plurality of micro structures for enlarging a light viewing angle in the length direction of the LED module.

2. The LED module of claim 1, wherein the plurality of micro structures are a plurality of micro protrusions from the lens body.

3. The LED module of claim 1, wherein the plurality of micro structures comprises a plurality of micro strip structures, the plurality of micro strip structures are arranged along a direction in parallel to the length direction, and each micro strip structure extends along a direction perpendicular to the length direction.

4. The LED module of claim 3, wherein each micro strip structure has an arc or triangle cross section.

5. The LED module of claim 1, wherein the lens body has a rotationally symmetrical shape except for the plurality of micro structures.

6. The LED module of claim 1, wherein the incident surface has a first incident surface and a second incident surface, the light transmitted by the first incident surface is incident on the emergent surface, and the light transmitted by the second incident surface is incident on the reflective surface and is reflected by the reflective surface to the emergent surface.

7. The LED module of claim 6, wherein the first incident surface is recessed toward the LED light source.

8. The LED module of claim 1, wherein each lens further comprises a mounting portion surrounding the lens body and an outer cavity is formed between the mounting portion and the lens body.

9. The LED module of claim 8, wherein the mounting portion comprises an outer circumference wall extending from the emergent surface and a mounting foot located at a free end of the outer circumference wall.

10. The LED module of claim 1, further comprising:
a printed circuit board assembly, wherein the one or more LED light sources are mounted on the printed circuit board assembly and each lens has a positioning post for positioning the lens onto the printed circuit board assembly; and
an over-molded plastic body for sealing the one or more LED light sources, the one or more lens and the printed circuit board assembly together.

11. A sign box comprising:
a box body having four side edges; and
one or more LED modules comprising:
one or more LED light sources; and
one or more lenses for covering the one or more LED light sources, each lens comprising a lens body and the lens body comprising an inner cavity having an incident surface, an emergent surface, and a reflective surface extending between the incident surface and the emergent surface for providing total internal reflection,
wherein one LED light source is situated in the inner cavity, light emitted from the LED light source is transmitted by the incident surface, at least portion of transmitted light by the incident surface is reflected by the reflective surface to the emergent surface so as to provide a narrow light beam angle perpendicular to a length direction of the LED module, and
wherein the emergent surface has a plurality of micro structures for enlarging a light viewing angle in the length direction of the LED module
wherein the one or more LED modules are mounted on at least one side edge of the box body along the length direction of the LED module.

12. The LED module of claim 11, wherein the plurality of micro structures are a plurality of micro protrusions from the lens body.

13. The LED module of claim 11, wherein the plurality of micro structures comprises a plurality of micro strip structures, the plurality of micro strip structures are arranged along a direction in parallel to the length direction, and each micro strip structure extends along a direction perpendicular to the length direction.

14. The LED module of claim 13, wherein each micro strip structure has an arc or triangle cross section.

15. The LED module of claim 11, wherein the lens body has a rotationally symmetrical shape except for the plurality of micro structures.

16. The LED module of claim 11, wherein the incident surface has a first incident surface and a second incident surface, the light transmitted by the first incident surface is incident on the emergent surface, and the light transmitted by the second incident surface is incident on the reflective surface and is reflected by the reflective surface to the emergent surface.

17. The LED module of claim 16, wherein the first incident surface is recessed toward the LED light source.

18. The LED module of claim 11, wherein each lens further comprises a mounting portion surrounding the lens body and an outer cavity is formed between the mounting portion and the lens body.

19. The LED module of claim 18, wherein the mounting portion comprises an outer circumference wall extending from the emergent surface and a mounting foot located at a free end of the outer circumference wall.

20. The LED module of claim 11, further comprising:
a printed circuit board assembly, wherein the one or more LED light sources are mounted on the printed circuit board assembly and each lens has a positioning post for positioning the lens onto the printed circuit board assembly; and
an over-molded plastic body for sealing the one or more LED light sources, the one or more lens and the printed circuit board assembly together.
